(19) United States
(12) Patent Application Publication
(10) Pub. No.: US 2003/0205218 A1
(43) Pub. Date: Nov. 6, 2003

(54) Fuel detection fuel injection

(76) Inventors: Michael Gene McIntyre, El Paso, TX (US); Tracy Dean McIntyre, El Paso, TX (US)

Correspondence Address: Michael Gene McIntyre, 6416 Isla Del Rey, El Paso, TX, 79912, US

(21) Appl. No.: 10/137,074

(22) Filed: May 2, 2002

(51) Int. Cl. F02M 51/00

(52) U.S. Cl. 123/494

(57) ABSTRACT

Our invention is new to the art of fuel injection because it enables the fuel injection system to evaluate the properties of the fuel in the system and then modify the quantity of fuel or time the injector is open for any given location on the fuel injection map with regards to and in relation to the fuel that is to be injected. The amount of fuel that is injected will be more accurate or a better match to the fuel that is going to be injected. We will have a more precise amount of fuel injected and their by have better fuel economy better power output and lower emissions. The present invention addresses the above and other needs by providing a method and system to achieve better fuel economy, lower emissions and better performance, than is available in today's fuel injection systems. As disclosed herein, after one or more sensors evaluates the fuel, the control module will modify the amount of fuel that is going to be injected. This modification will be in relation to the fuel's properties. the modification will achieve a more accurate metering of the fuel being delivered/injected. This system will work in conjunction with existing fuel injection technologies that are common to anyone skilled in the field of fuel injection, The above-identified methods and systems can be utilized alone or in conjunction with other fuel system controlling techniques. Additionally, each of the specific steps involved in the processes, described herein are easily modified or tailored to meet the peculiar design and operational requirements of the particular engine and the anticipated operating environment in which the engine is used.

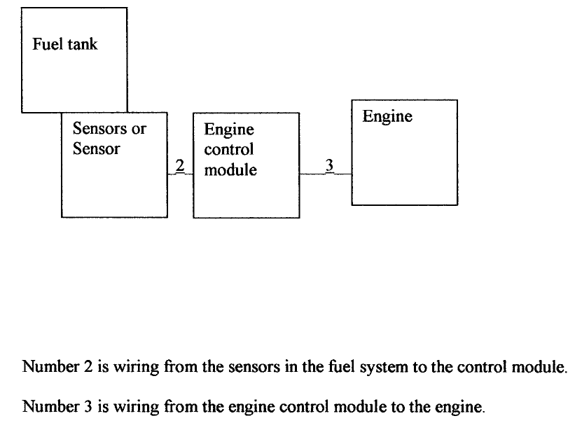

From the foregoing, it should be noted that the invention provides a method and system for the detection of fuel used in an electronically controlled engine. While the invention disclosed herein has been described by us to the best of our ability, numerous modifications and variations can be made thereto by those skilled in the art without departing from the scope of the invention as set forth in the claims or sacrificing all its material advantages.

A system and method of modifying a fuel injection map after evaluation of the fuel in the fuel system. This system and method will (automatically) evaluate the properties of the fuel (while in the fuel system) used in an electronically controlled fuel injected internal combustion engine. This system will automatically modify the fuel injection map thereby correcting the amount of fuel injected into the engine based on any one of the following or all of the following evaluated properties of the fuel. The properties to be evaluated would include but would not be limited to the specific gravity, octane, vapor pressure, sulfur content, oxidation stability, distillation properties, vapor-liquid ratio, phosphorus content, density, relative density, MTBE, ETBE, TAME, DIPE, tertiary-amly alcohol, C1 to C4 alcohol, gasoline-oxygenate blends and fuel temperature. This system will produce the most significant improvements in, fuel economy, power output, drivability, as well as lowering emissions, etc. during the open loop function of current fuel injection technologies, but will also produce these same benefits during the closed loop operation. By modifying the maps output we can facilitate achieve better fuel economy more power, better derivability and lower emissions. A fuel injection system that has the added ability to modify the fuel map's quantity in relation to the properties of the fuel that is in the fuel system will be an added benefit. Inside of the fuel system of this electronically fuel injected vehicle will be a sensor/sensors that will take readings of the properties of the fuel. These readings will be sent to the control module of the fuel injection system. The control module will decide based on these readings the amount of additional fuel or how much fuel needs to be subtracted from the maps base volume. This addition or subtraction can be made before, during or after any additions or subtractions have been made on behalf of the other common sensors of today's fuel injection systems. Once the appropriate fuel amount has been determined the system will perform in a similar manner as current fuel injection systems. In addition to these features this invention will use some or all of the standard components in today's fuel injection systems. The control module will be modified to accept readings from a bank of sensors located in the fuel system. This bank of sensors will test the quality, characteristics and properties of the fuel. The properties to be evaluated would include but would not be limited to the specific gravity, octane, vapor pressure, sulfur content, oxidation stability, distillation properties, vapor-liquid ratio, phosphorus content, density, relative density, MTBE, ETBE, TAME, DIPE, tertiary-amly alcohol, C1 to C4 alcohol, gasoline-oxygenate blends, fuel temperature, etc. When the control module encounters a fuel that has a certain characteristic or characteristics the control module will calculate the amount of fuel that should be subtracted or added to the maps base fuel amount. After the maps base amount of fuel has been modified the fuel injection system will function the same as today's common fuel injection systems until some other fuel characteristic has been detected. At which point the control module will recalculate the amount of fuel that is to be added to or subtracted from the base amount of fuel. The above-identified methods and systems for the identification of fuel in an engine can be utilized alone or in conjunction with other fuel system controlling techniques. Moreover, each of the specific steps involved in the processes, described herein are easily modified or tailored to meet the peculiar design and operational requirements of the particular engine and the anticipated operating environment in which the engine is used.

### CROSS REFERENCE

Not applicable

### FEDERAL SPONSORSHIP

Not applicable

### BACKGROUND

The invention relates to a fuel detection system or identification system of fuel for an electronically controlled engine, and more particularly, to a system that will recalibrate the amount of fuel delivered to an engine after considering the properties of the fuel to be delivered and method for the detection and identification of the fuel used in electronically controlled (fuel injected) internal combustion engines. If the detected fuel is identified as having a certain set of characteristics or characteristic, for example high specific gravity due to alcohol additives, then the control module will make an addition to the amount of fuel to be injected for any given set of conditions applied to the fuel injection system. On the other hand if the detected fuel has a low specific gravity, low or no alcohol additives and no sulfur additives then the control module will make a subtraction in the amount of fuel that is to be injected for any given set of conditions applied to the fuel injection system. This invention can be added to the existing fuel injection systems on current autos by adding to the fuel injection programming, the ability to make an addition or subtraction to the maps base line fuel amount after the fuel has been evaluated. For example current auto technologies employ a base map and this base map is modified after taking into consideration the conditions applied to various sensors. Current technologies use such sensors as air temperature, air mass, water temperature and so on. With this invention we will use all current technologies and add in the ability to evaluate the fuel's properties. Once the fuel has been evaluated the fuel injection control module will make an addition or subtraction to the maps base fuel amount and more accurately inject the proper amount of fuel.

Common fuel injection system use a control model which contains a base line map that will give a basic amount of fuel for any given set of parameters which commonly include RPM & throttle position etc. After the basic fuel amount has been determined the control module will Add to or subtract from this basic amount of fuel using the information supplied from a myriad of sensors which commonly include water temp, air temp, mass air, load applied to the engine and so on. The final fuel amount will be determined from the forgoing. This is in open loop operation. After the engine gets warmed up to a predetermined temperature the control module will go in to closed loop function IE the O2 sensor will evaluate the amount of O2 in the exhaust stream after all of the previous evaluations happen the O2 sensor will tell the control module that it is rich or lean then the control module will effect an addition or subtraction of the amount of fuel to be injected in to the engine the is an ongoing process. This is a very good way to achieve fuel economy good performance and low emission. However while the engine is in open loop operation it has no ability to evaluate the mistakes it is making with regards to the amount of fuel it is injecting. Do to this shortcoming the engine manufactures tend to run the engine slightly rich to guaranty that there will be no engine damage and or drivability problems do to lean fuel air ratios wile in open loop. Also when in closed loop operation if the throttle is opened quickly the fuel injection has to revert back to the base fuel map in the seconds after the throttle is opened quickly the O2 readings are not considered and during this time the fuel delivery is on the rich side as well.

To make things harder on the manufactures the fuel that is supplied for use in the engine can have different properties. The properties of the fuel have a large effect on how much fuel needs to be injected for proper operation. For example when the fuel at the pumps is oxygenated you will need to inject more of it for proper fuel air ratio this must be factored in to the base fuel map or the engine will run lean during the months that the fuel at the pumps is oxygenated. So it is clear that during the months that the fuel is not oxygenated the base fuel map will be to rich during warm up and fast throttle opening as well as at other times. Clearly it would be better if the fuel injection system could evaluate the fuel and then compensate for the fuels properties before the fuel is injected.

Although the fuel that is readily available at the pumps is manufactured under tight guidelines there are still large variances in the fuels' properties. For example the fuels' vapor pressure, specific gravity and alcohol content as well as many other additives and properties have an effect on the engines drivability, economy, emissions and power output. The ASTM Designation: D4814-01a list 6 categories of drivability with respect to fuel vapor pressure alone, the ability to detect the vapor pressure of the fuel being delivered to the engine would allow the control module to correct any drivability problems by modifying the fuel map quantity/volume for any giving vapor pressure. Specific gravity of the fuel has a great impact on the amount of fuel that needs to be delivered to the engine to achieve the proper air to fuel ratio. Since the weight of the fuel changes dramatically when alcohol and oxygenated blends are added. It will be advantageous to modify a fuel map's quantity/volume after considering the specific gravity or the weight of the fuel. Fuel temperature will affect the amount of fuel that is needed for the proper fuel air ratio. If the fuel is cold it will remove heat from the intake tract making the intake air denser, consequently the engine will need more fuel for the proper fuel air ratio. Other onboard tests may be utilized to evaluate fuel to achieve better fuel economy better emissions and better performance. The invention would employ at least all or part of the appropriate test/evaluation processes as found in the ASTM Designation; D 4814-01a Standard Specification for Automotive Spark-ignition Engine Fuel1, as well as all other test used to evaluate fuels. The ability of autos to evaluate the fuel in their own systems and then compensate for a large variety of fuels will allow the fuel manufactures to supply a broader range of fuel that may have more of the alcohol or oxygenate blends which will give cleaner emissions without causing derivability problems.

### BRIEF SUMMARY OF THE INVENTION

The invention is going to enable the fuel injection system to determine the properties of the fuel that is about to be injected in to the engine using information that will be obtained by a sensor or bank of sensors in the fuel system. Using this information the control module will be able to add or subtract from the map's base amount this new amount will better suit the fuel that is about to be injected. Choosing a more accurate amount of fuel will give better fuel economy better power and lower emissions. The most notable improvements will be during the open loop operation of normal fuel injection systems operation but there will also be improvements in the closed loop operations. Prior to going to closed loop operation today's fuel injection systems rely on a map that was manufactured for one type or quality of fuel. However the fuel that is at the pumps today has a large variance in the way it is manufactured. Some fuels are designed to pollute less during government-mandated months of the year. Currently the fuel available at the pumps today has three choices of octane to choose from. Different countries and or states have different regulations on fuel content. If we can ascertains the properties of the fuel prior to injecting them we can improve fuel economy and drivability as well as decrease emissions. Additionally we will be able to use a broader range of fuels in our vehicles thereby allowing the fuel manufactures to use more anti pollutant fuel combinations as well as lower the cost of fuel production.

### BRIEF DESCRIPTION OF THE DRAWINGS

The above and other aspects, features, and advantages of the present invention will be more apparent from the following, more descriptive description thereof, presented in conjunction with the following drawings, wherein:

FIG. I is a flow chart showing the fundamentals of the fuel detection fuel injection system.

### DETAILED DESCRIPTION OF TIE INVENTION

The following description is of the best mode presently contemplated for carrying out the invention. This description is not to be taken in a limiting sense, but is made merely for the purpose of Describing.

The general principals of the invention. The scope and breadth of the invention should be Determined with reference to the claims. The invention will contain a bank of sensors or sensor that will test the properties of the fuel in the fuel system. The information from the bank of sensors will be received by the fuel injection control module the control module will ascertain what the properties of the fuel are. Using this information the control module will make the computation to add or subtract from the maps base amount. For instance if we encounter a fuel with I percent MTBE added we will make an addition to the amount of fuel to be injected. The amount to be added will be programmed in to the control module and it will vary greatly on other factors for example engine size, RPM and so on. The control module will be programmed to recognize all the different fuel combinations available at the pumps to day and beyond that it will be programmed to recognize and accommodate fuel combinations that are not at the pumps to day but that may be available in the future.

The above-identified methods and systems for the identification of fuel in an engine can be utilized alone or in conjunction with other fuel system controlling techniques. Moreover, each of the specific steps involved in the processes, described herein are easily modified or tailored to meet the peculiar design and operational requirements of the particular engine and the anticipated operating environment in which the engine is to be used.

What is claimed is:

1. A fuel injection system of a motorized vehicle that has on board the vehicle and inside the fuel system a sensor or bank of sensors that continuously evaluates the properties of the fuel in the system. The properties to be evaluated would include but not be limited to: specific gravity, octane, vapor pressure, sulfur content, oxidation stability, distillation properties, vapor-liquid ratio, phosphorus content, density, relative density, ABE content, ETBE content, TAME content, DIPE content, tertiary-amly content, alcohol content, C1 to C4 alcohol content, gasoline-oxygenate blends, fuel temperature, etc. Once the properties of the fuel have been ascertained the information will be received by the control module of the fuel injection system.

2. A fuel injection system of a motorized vehicle that has a control module modified to vary the amount of fuel to be injected after considering the fuel's properties. When prompted by incoming information concerning the fuel's properties this control module will add to or subtract from the amount of time the control module opens the fuel Injector. And or how far the fuel injector is opened. In layman's terms the amount of fuel that is to be injected by any means.

3. A fuel injection system of a motorized vehicle that has on board the vehicle and inside the fuel system a sensor or bank of sensors that continuously reads the properties of the fuel in the system. The properties to be read would include but not be limited to: specific gravity, octane, vapor pressure, sulfur content, oxidation stability, distillation properties, vapor-liquid ratio, phosphorus content, density, relative density, MTBE content, ETBE content, TAME content, DIPE content, tertiary-amly content, alcohol content, C1 to C4 alcohol content, gasoline-oxygenate blends, fuel temperature, etc. Once the properties of the fuel have been ascertained the information will be sent to the control module of the fuel injection system. Additionally this fuel injection system has a control module that has been modified to add to or subtract from the amount of fuel to be injected with regards to and after the control module has evaluated the properties of the fuel that is to be injected. The control module will receive the readings from the sensor/sensors. Then the control module will Add to or subtract from the amount of time that the injector is to be open. And or how far the injector is opened. Or in layman's terms the amount of fuel that is to be injected by any means. Their by once the computation has been made the control module will correctly and accurately inject fuel into the engine based on the fuels properties. By using this method we will achieve better power, fuel economy, drivability and lower emissions. This system will work in conjunction with existing fuel injection technologies that are common to anyone skilled in the field of fuel injection.
